(19) United States
(12) Patent Application Publication
(10) Pub. No.: US 2023/0410212 A1
(43) Pub. Date: Dec. 21, 2023

(54) MATCHING VALIDATION

(71) Applicant: Intuit Inc., Mountain View, CA (US)

(72) Inventors: Hadar LACKRITZ, Tel Aviv (IL); Natalie BAR ELIYAHU, Petah Tikva (IL); Yaakov TAYEB, Petah Tikva (IL); Sigalit BECHLER, Petah Tikva (IL)

(73) Assignee: Intuit Inc., Mountain View, CA (US)

(21) Appl. No.: 17/827,530

(22) Filed: May 27, 2022

(51) Int. Cl. G06Q 40/00

(52) U.S. Cl. CPC G06Q 40/12

(57) ABSTRACT

Matching validation includes obtaining a candidate match between a target entity and a candidate application user and filtering multiple transaction records of multiple application users to obtain a subset of the transaction records each involving a transaction with the target entity. The application users exclude the candidate application user. Matching validation further includes determining, for each transaction record in the subset, whether a matching transaction record exists in multiple candidate users transaction records of the candidate application user, and validating the candidate match when at least a threshold amount of transaction records in the subset has the matching transaction record in the candidate users transaction records.

### BACKGROUND

With the Internet and the ease at which data is generated, computers manage large volumes of data. One challenge when managing such volumes is identifying and handling entity duplication while at the same time ensuring data security. Entity duplication occurs when multiple records for the same real-world entity exists and appear associated with different real-world entities. One manner in which entity duplication occurs is when a user or external system inputs a new entity, such as by being a counterparty to a transaction, without realizing that the entity is already present in the system. For security, the user cannot be asked whether the user is referring to the existing entity without potentially exposing confidential information of the existing entity. For example, the confidential information may be the fact that the existing entity is a user of the system.

In storage systems and server processes, entity duplication can cause data integrity problems with some information of the entity being updated while other information is not updated. Thus, the server may respond to server requests with incorrect or incomplete information. Further, when multiple entries for an entity exists, deleting the entity can be a challenge.

Even if the duplicates of the same entity are identified, data security may prevent validation that the entities are, in fact, the same. For example, the duplicated entity cannot be asked without revealing potentially confidential data from another entity, such as the existence of a relationship with another entity. Thus, a challenge exists in large data systems to identify duplicate entities, match the duplicate entities, and validate the match while maintaining the security of the overall system.

### SUMMARY

In general, in one aspect, one or more embodiments relate to a method that includes obtaining a candidate match between a target entity and a candidate application user, and filtering multiple transaction records of multiple application users to obtain a subset of the transaction records each involving a transaction with the target entity. The application users exclude the candidate application user. The method further includes determining, for each transaction record in the subset, whether a matching transaction record exists in multiple candidate users transaction records of the candidate application user and validating the candidate match when at least a threshold amount of transaction records in the subset has the matching transaction record in the candidate users transaction records.

In general, in one aspect, one or more embodiments relate to a system including a data repository including multiple transaction records and multiple candidate users transaction records. The system further includes at least one computer processor. A matching model executes on the at least one computer processor and is configured to generate a candidate match between a target entity and a candidate application user. The system further includes a validation model executing on the at least one computer processor. The validation model is configured to filter the transaction records of multiple application users to obtain a subset of the transaction records each involving a transaction with the target entity. The application users exclude the candidate application user. The validation model is further configured to determine, for each transaction record in the subset, whether a matching transaction record exists in the candidate users transaction records of the candidate application user and validate the candidate match when at least a threshold amount of transaction records in the subset has the matching transaction record in the candidate users transaction records.

In general, in one aspect, one or more embodiments relate to a method including calculating a normalized distance between a target entity and each of multiple candidate application users, selecting a candidate application user from the candidate application users as a candidate match with the target entity based on the normalized distance satisfying a threshold distance, and selecting a subset of transaction records in multiple transaction records of multiple application users that comprise an address of the target entity as a counterparty of a transaction. The application users exclude the candidate application user. The method further includes determining, for each transaction record in the subset, whether a matching transaction record exists in multiple candidate user transaction records of the candidate application user. Determining a matching transaction record exists for a transaction record in the subset includes determining that a candidate user transaction record is equal and opposite to the transaction record in the subset. The method further includes validating the candidate match when at least a threshold amount of transaction records in the subset has the matching transaction record in the candidate users transaction records.

Other aspects of the invention will be apparent from the following description and the appended claims.

### BRIEF DESCRIPTION OF DRAWINGS

FIG. 1 is a diagram of a system in accordance with one or more embodiments.

FIG. 2 is a flowchart in accordance with one or more embodiments.

FIGS. 3, 4, 5, and 6 shows an example in accordance with one or more embodiments of the invention.

FIGS. 7A and 7B show a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention are directed to handling entity duplication. Entity duplication occurs when a same real-world entity is represented multiple times in storage. One or more embodiments may be directed to preventing entity duplication or to removing duplicate entities. Generally, an entity is an individual, business entity, family, or other collection of individuals. Entities may be users of a software application (i.e., application users) that have an account with the system. Entities may be merchants, customers, and suppliers that work with each other. Entities that are application users may input information about other entities into the software application that manages their respective transactions. When the application user inputs the entity information, the application user may not know or link the other entity to another application user. Thus, a duplicated entity may exist in the system.

Preventing entity duplication may be performed by, when receiving new entity information of a new entity, matching the new entity to an application user, and validating the match. For example, if a new transaction record is entered that references a new entity, the matching and validation may be performed to change the transaction record to reference the application user. Removing duplicates may include traversing the entities that are referenced in storage and not associated with an application user, to determine whether the entity is an application user.

Matching is performed using a machine learning. However, such matching process has a probability of error. Because of security requirements, virtually no probability of error is allowed. Thus, a subsequent validation procedure is performed. From the matching model, a candidate match is obtained that includes a target entity and a candidate application user. Transaction records of other application users are filtered to only have a subset that are for transactions with the target entity. The other applications users do not include the candidate application user or the target entity. For each transaction record in the subset, a determination is made whether a matching transaction record exists in the transaction records of the candidate application user (i.e., the candidate application user transaction records). The matching transaction record indicates that the candidate application user is a counterparty to the transaction with the other user application users, even though the transaction record indicates that the target entity is the counterparty. By validating that the candidate application user is the target entity, the target entity may be linked to the candidate application user. Thus, the storage, resource usage, and data repository consistency problems of duplicated entities may be mitigated while maintaining security of the system.

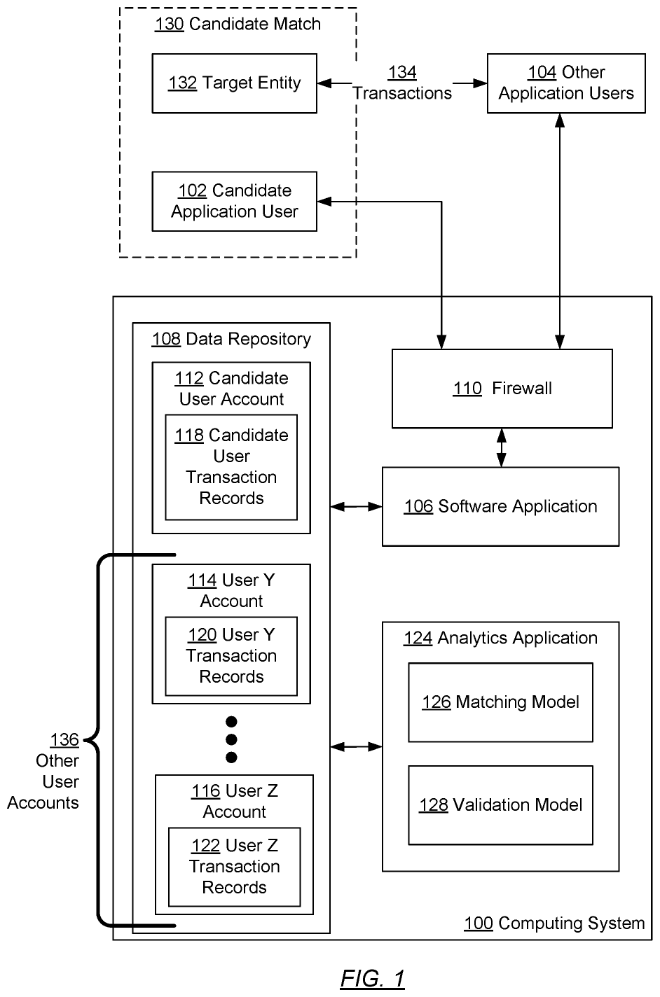

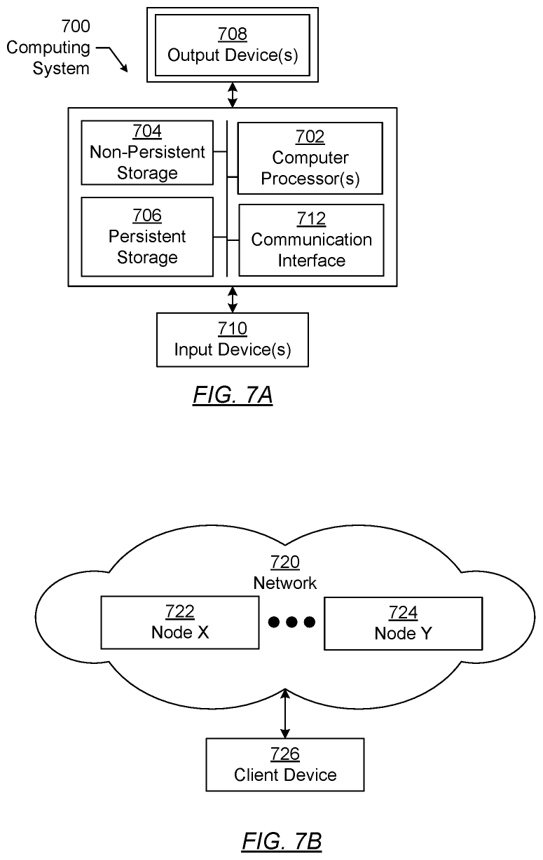

FIG. 1 is a diagram of a system in accordance with one or more embodiments. As shown in FIG. 1, the system includes a computing system (100), which is connected to application users (e.g., candidate application user (102), other application users (104)). The computing system (100) may be, for example, the computing system described below in reference in FIG. 7A and 7B.

The computing system (100) includes a software application (106) connected to a data repository (108) and a firewall (110). The software application (106) is any type of software application that manages transactions for application users (e.g., candidate application user (102), other application users (104)). An application user is an entity that is a user of the software application (106). Namely, an application user has an account with the software application (106). A transaction is an exchange between two different entities. A transaction may be a business transaction, a computer transaction, a financial transaction for a good or service, or other type of transaction. For example, the software application (106) may facilitate the transactions and/or record the transactions. Some of the transactions may be between application users while other transactions may be between an application user and a third party entity.

By way of an example, the software application (106) may be a financial application that records financial transactions. The financial application may be a financial application of a financial institution that has a financial account for the account holders of the financial institution. As another example, the financial application may be a third party financial application that generates reports for application users.

The software application (106) may be another type of software application, such as a security application that logs security related information for users, an insurance provider application, or another type of application.

The software application (106) is connected to a data repository (108). Generally, the data repository (108) is any type of storage unit and/or device (e.g., a file system, database, collection of tables, or any other storage mechanism) for storing data. Further, the data repository (108) may include multiple different storage units and/or devices. The multiple different storage units and/or devices may or may not be of the same type or located at the same physical site.

The data repository (108) includes functionality to store user accounts (e.g., candidate user account (112), user Y account (114), user Z account (116)). A user account is a storage structure for a particular application user. The user account may include administrative information, such as account identifier, name, other names, address (e.g., one or more physical addresses and email addresses), ownership information in the case of a business entity, and other information about the application user. Additionally, the user account includes transaction records (e.g., candidate user transaction records (118), user Y transaction records (120), user Z transaction records (122)). A transaction record is a recording of a particular transaction. A transaction record may have a timestamp recording the date and, optionally, the time of the particular transaction. The transaction record may also have an amount, such as a monetary amount of the transaction. Further, the transaction record may have a type indicating a type of transaction. For financial transactions, the type may be credit, debit, invoice, bill, etc.

For transaction records between application users, the types of transaction are opposites. Opposite types are types that are for different sides of the same transaction. For example, the opposite type of a bill is an invoice, because when a first entity sends an invoice to a second entity, the second entity receives the invoice as a bill to pay. The opposite of the credit is a debit, because when the account of a first entity is credited for the transaction, the account of the second entity is debited. By way of another example, the opposite of the income is a cost, because when the account of a first entity shows an income for the transaction, the account of the second entity shows a cost.

Two transaction records of different user accounts are equal and opposite when the transactions have the same timestamp, or portion thereof (e.g., same date but different time), have the same amount, and are for opposite sides of the transaction.

Continuing with FIG. 1, the computing system (100) includes a firewall (110) between the software application (106) and data repository (108) and external systems, such as entities outside of the computing system that are connected via a network (not shown). The firewall (110) prevents unauthorized access to the data repository (108). Authorized access is access of an application user to the application user's particular user account. Unauthorized access is access of an application user or even another entity to any user account that is not for the application user or other entity. The firewall (110) may be part of an access manager and identity server to control access to user accounts. Thus, the firewall (110) is interposed between the application users (e.g., candidate application user (102), other application users (104)) and the resources of the computing system (100) including the software application (106) and the data repository (108).

An analytics application (124) is behind the firewall (110) on the computing system (100). The analytics application (124) includes functionality to access the data repository (108) and perform analytics on the user accounts in the data repository. One type of analytics is to match and validate target entities with application users. The analytics application (124) includes a matching model (126) and a validation model (128).

The matching model (126) is an artificial intelligence (AI) model that is configured to identify a candidate match (130) between a target entity (132) and a candidate application user (102). The target entity (132) is the entity that is unknown as to whether the entity is also an application user. The target entity (132) is the target of attempting to identify whether the target entity is the same as the application user. For example, the target entity (132) may be identified based on being a counterparty to more than a threshold number of transactions recorded in transaction records without being associated with a user account. By way of another example, the target entity (132) may be a new entity that is being input by an application user into the software application (106).

The candidate application user (102) is the candidate that the matching model (126) returns as being the same as the target entity (132) with a certain probability. Specifically, the matching model (126) identifies the candidate application user (102) as having more than a threshold probability of being the same entity as the target entity (132). The target entity (132) and, possibly, the candidate application user (102) may perform one or more transactions (134) with other application users (104). Other application users (104) include other application users of the software application (106) that exclude the candidate application user (102). In one or more embodiments, the other application users (104) include all other users of the software application. At least a subset of the other application users (104) may be counterparties to the transactions with the target entity (132). Thus, for a particular candidate application user (102), the data repository (108) has a candidate user account (112) for the candidate application user (102) and other application user accounts (136) for the other application users (104).

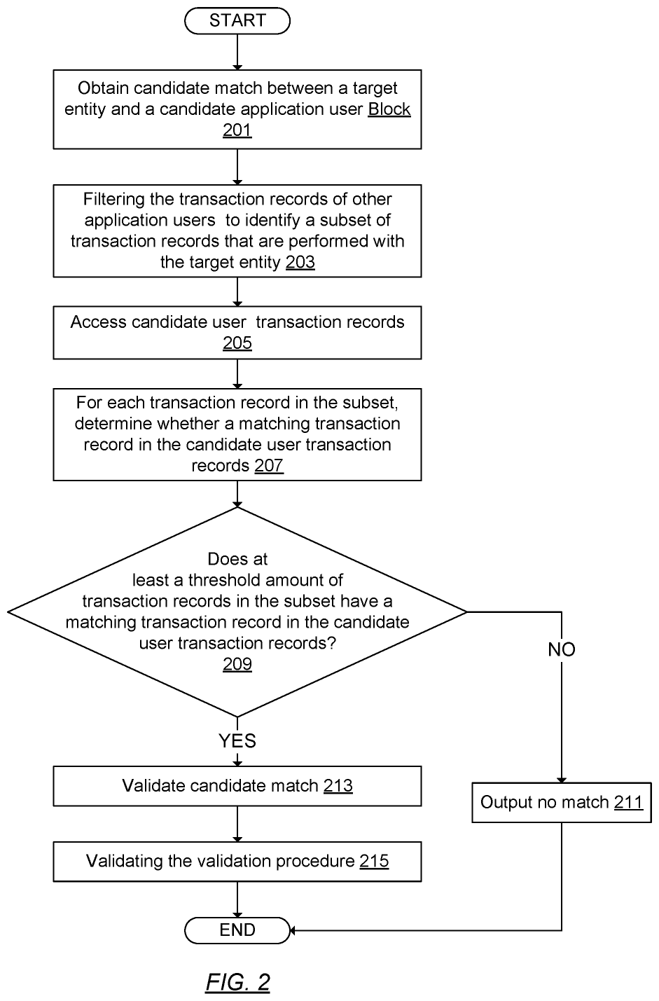

The validation model (128) is configured to validate the candidate match (130) to generate a validated match. Validating a match by the validation model is described below and in reference to FIG. 2. In one or more embodiments, the validation model (128) filters the transaction records in the data repository (108) to identify a subset of transaction records in other user accounts that identify the target entity (132) as the counterparty of the transaction. For each transaction record in the subset, a determination is made whether a matching transaction record exists in the candidate user account (112). If more than a threshold amount of transaction records is in the account, then the candidate match (130) is validated. Namely, even though the transaction record in the subset is directed to the target entity (132), the transaction record identifies matching transaction record stored by the candidate application user indicating that the target entity (132) and the candidate application user (102) are one and the same. Because the validation model (128) is behind the firewall (110), the validation model (128) has full access to the transaction records in the data repository (108). However, the data security is managed because transaction records are not copied outside of the computing system, even to remote administers computers, in order to perform the validation.

By using the validation technique, embodiments may provide 100% confirmation of a candidate match while at the same time securing the underlying data. Further, there is no user friction because a user does not need to perform any steps to perform the validation. Validation by users or even confirmation is not needed. Thus, a system with hundreds of thousands or even millions of users can validate candidate matches in a seamless and quick manner providing confirmation of the match without user involvement.

While FIG. 1 shows a configuration of components, other configurations may be used without departing from the scope of the invention. For example, various components may be combined to create a single component. As another example, the functionality performed by a single component may be performed by two or more components.

FIG. 2 is a flowchart in accordance with one or more embodiments. While the various steps in this flowchart are presented and described sequentially, one of ordinary skill will appreciate that some or all of the steps may be executed in different orders, may be combined, or omitted, and some or all of the steps may be executed in parallel.

In Block 201, a candidate match between a target entity and a candidate application user is obtained. In one or more embodiments, the matching model iterates through transaction records to identify possible matching transaction records. For example, when a new target entity is received, the matching model may attempt to determine whether a candidate application user exists that is the same as the target entity. The matching model may be a classifier. For example, the matching model may be a recurrent neural network that takes, as input, information of a target entity as features for input to the model and output a class that identifies the candidate application user.

In another embodiment, the classifier is configured to detect if two companies are the same or not. For example, the classifier may receive as input two strings “Pro Med Billing” and “Professional Medical Billing LTD., Inc.”, and output a probability that the two strings are aliases of the same company. The classifier may further integrate other entity information such as names, addresses, email addresses, etc.

In another embodiment, the matching model may operate by using distances between names or other administrative information about a target entity. For example, the matching model may calculate a normalized distance between a name of the target entity and a name of the candidate application user and set the target entity and the candidate application user as the candidate match based on the normalized distance satisfying a threshold distance. The name of the target entity may be a first string that is compared to the name of the candidate application user as a second string. As another example, the name of the target entity combined with the address information of the target entity may be a first string that is compared against the corresponding name and address information of the candidate application user. The normalized distance may be, for example, a Levenshtein distance, an edit distance, or another distance between strings.

Regardless of the manner in which a candidate match is identified, the candidate match may have less than 99% accuracy level. In a system in which any release of secure data is not allowable, even though there is a high likelihood of being correct for any particular match, the chance of failure may be deemed too high. As such, embodiments perform the validation procedure described below.

In Block 203, the transaction records of other application users are filtered to identify a subset of transaction records that are performed with the target entity. In one or more embodiments, the validation model filters the transaction records in the data repository by querying the data repository for transaction records that satisfy a criterion of identifying the target entity as the counterparty to the transaction. For example, the transaction record may have the name, email address, or other unique identifier of the target entity as being a counterparty of the transaction. The subset of the transaction records are transaction records of other application users that do not include the candidate application user. Notably other application users may exist that do not have any transaction records identifying the target entity.

In Block 205, the candidate user transaction records are identified. The candidate user account is identified for the candidate user.

In Block 207, for each transaction record in the subset, a determination is made whether a matching transaction record is in the candidate user transaction records. A matching transaction record is an equal and opposite transaction record to the transaction record in the subset. The validation model iterates through the transaction record in the subset and attempts to identify a matching transaction record in the candidate user transaction records. For example, the validation model may determine whether the candidate user has a transaction record having the same timestamp and amount as a particular transaction record in the subset. If such a transaction record exists, the validation model may further optionally determine whether the transaction record is for the opposite type of transaction. If a transaction record exists in the candidate user account that is equal and opposite to the transaction record in the subset, then the transaction record in the subset is determined to have a match. The process repeats for each transaction record in the subset. Notably, other transaction records may exist in the candidate user account that are for transactions with external entities. Thus, the system only performs the one way match.

In Block 209, a determination is made whether at least a threshold amount of the transaction records in the subset have a matching transaction record in the candidate user transaction records. After iterating through the transaction records, the determination is made whether at least a threshold amount of transaction records in the subset have a match. For example, the threshold amount may be one hundred percent to avoid potentially exposing secure and confidential information. The threshold amount may be less than 100% if some tolerance for error is permitted.

If a least the threshold is not found, then no match is outputted in Block 211. In such a scenario, the system may return to the matching model to obtain a new candidate match. In another example, the validation model may iterate through a set of candidate matches to identify either a validated match or no match. If no match is found, the computing system may treat the target entity as a new entity and associate a unique entity identifier for the new entity. The computing system may then continue to identify and validate possible matches.

Returning to Block 209, if a threshold number of transaction records have a matching transaction record, the flow proceeds to Block 213 where the candidate match is validated. In such a scenario, the computing system confirms that the target entity is the candidate application user, and thus, the match is a validated match. By validating the match, various operations may be performed. The firewall blocks access to the software application and transaction records to unauthorized user. Prior to validation, the target entity is an unauthorized user and an authorized user after validation. For example, the candidate application user account or a portion thereof may be exposed to the target entity. As another example, in each transaction record in which the target entity is identified, the unique identifier of the candidate application user may be appended or otherwise used to augment the transaction record. In another example, promotions may be presented to the target entity based on having a user account with the software application.

In some embodiments, prior to performing operations based on validating the candidate match in Block 213, the validation procedure is validated. Validating the validation procedure is based on determining the probability of a false validation. In order to calculate the probability of a wrong match to pass the validation process, the subset of transactions of other application users are matched to transaction records of a randomized sample of other users (i.e., not the candidate application user or target entity). The percentage of users that have randomly the same transactional information represents the probability of a false alarm error. The false alarm rate is the rate of matches that have the same transactional information even though the transaction record does not reference the same transaction. If false alarm rate is less than a threshold percentage of transaction records in the subset, then the validation procedure is validated. In some embodiments, the validation procedure is validated if a false alarm rate of a maximum of 0.001.

One or more embodiments achieve zero user friction. In embodiments disclosed, only internal data is used, and the application user is not aware of our validation process. Because the application user is uninvolved, availability of the application user is not needed.

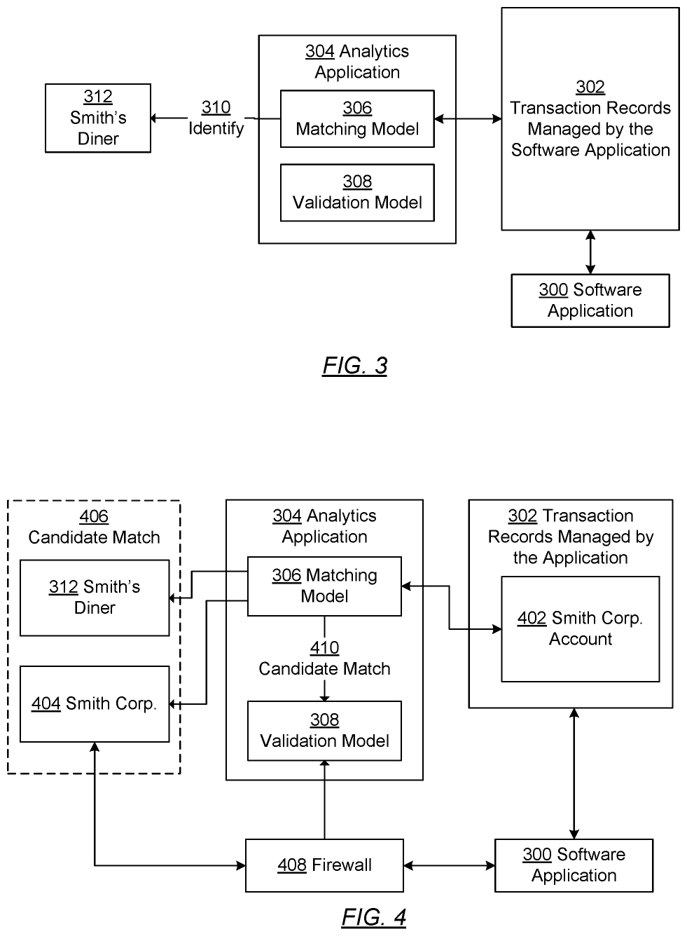

The following example is for explanatory purposes only and not intended to limit the scope of the invention. FIGS. 3, 4, 5, and 6 show an example in accordance with one or more embodiments of the invention.

Turning to FIG. 3, a software application (300) updates transaction records (302) managed by the software application. An analytics application (304) includes a matching model (306) and a validation model (308). The analytics application (304), in particular, the matching model (306), performs analytics on the transaction records (302). The matching model (306) identifies (310) a new target entity, Smith's Diner (312), in the transaction records. For example, Smith's Diner (312) may be referenced more than a threshold number of times in the transaction records. Thus, the matching model (306) checks whether a match exists for the target entity of Smith's Diner (312).

Turning to FIG. 4, the matching model (306) identifies, using the Smith Corp. Account (402) in the transaction records (302), Smith Corp. (404) as being a candidate match (406). For example, the matching model (306) may determine that an address of Smith's Diner (312) is close to an address of Smith Corp. (404) and the edit distance of the names are within a threshold distance. Smith Corp. is an application user and, thus, connects to the software application (300) and the transaction records (302) via a firewall (408). When the matching model (306) identifies the candidate match (406), the matching model (306) sends the candidate match (410) to the validation model (308). The validation model validates the candidate match (406).

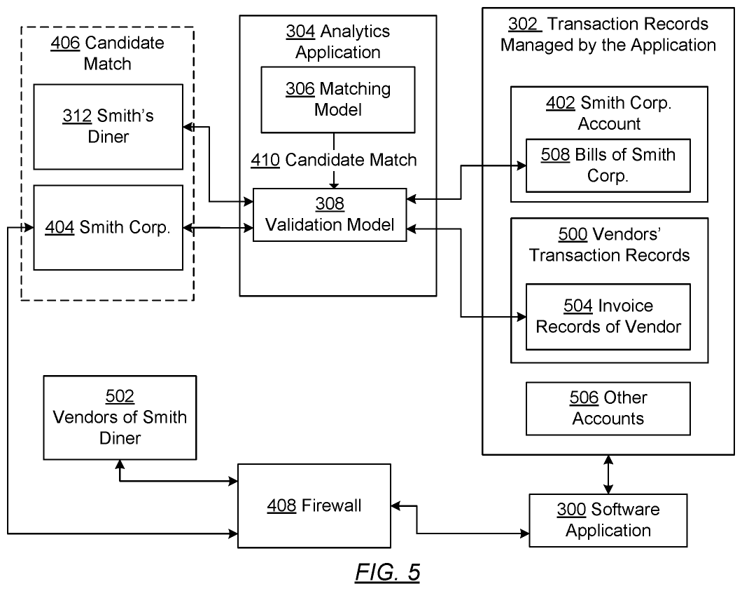

Turning to FIG. 5, the validation model (308) filters the transaction records (302) to obtain a set of vendor transaction records (500) of vendors of Smith's Diner (502). For example, the each of the vendor transaction records (500) may reference an address of Smith's Diner (312). By way of a more detailed example, the vendor transaction records (500) may include invoice records of the vendor (504). In the example, the invoice records of the vendor (504) are the subset of the transaction records (302). Other accounts (506) may also exist. For each invoice in the invoice records of the vendor (504) that reference Smith's Diner (312), a determination is made whether a matching record exists in Smith Corp. Account (402). The matching transaction record for an invoice record (i.e., record of an invoice) may be in the bill records of the Smith Corp. (508).

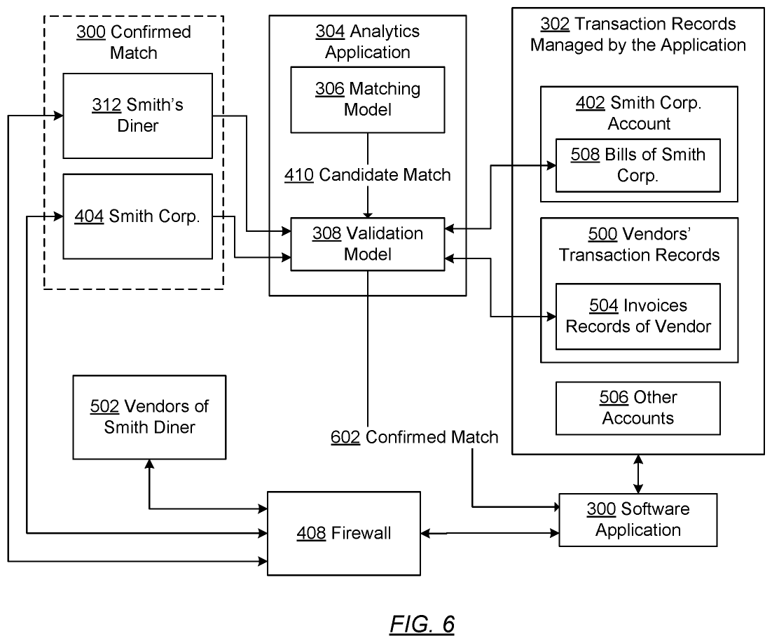

Turning to FIG. 6, if each transaction record in the subset has a matching transaction record in the Smith Corp. Account (402), the candidate match becomes a confirmed match (600). Notification of the confirmed match (602) is sent to the software application (300). The firewall (408) may then grant access to Smith's Diner (312). Via the firewall (408), the software application (300) may send promotions and other opportunities to Smith's Diner (312) based on the Smith Corp. (404) account.

By providing a technique whereby matches may be validated without human interaction, one or more embodiments provide a technique to minimize entity duplication in a large data store while maintaining data integrity and security of the overall system.

Embodiments of the invention may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 7A, the computing system (700) may include one or more computer processors (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (712) (e.g., Bluetooth interface, infrared interface, network interface, optical interface, etc.), and numerous other elements and functionalities that implement the features and elements of the disclosure.

The computer processor(s) (702) may be an integrated circuit for processing instructions. For example, the computer processor(s) may be one or more cores or micro-cores of a processor. The computing system (700) may also include one or more input devices (710), such as a touchscreen, keyboard, mouse, microphone, touchpad, electronic pen, or any other type of input device.

The communication interface (712) may include an integrated circuit for connecting the computing system (700) to a network (not shown) (e.g., a local area network (LAN), a wide area network (WAN) such as the Internet, mobile network, or any other type of network) and/or to another device, such as another computing device.

Further, the computing system (700) may include one or more output devices (708), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704) , and persistent storage (706). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (700) in FIG. 7A may be connected to or be a part of a network. For example, as shown in FIG. 7B, the network (720) may include multiple nodes (e.g., node X (722), node Y (724)). Each node may correspond to a computing system, such as the computing system shown in FIG. 7A, or a group of nodes combined may correspond to the computing system shown in FIG. 7A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (700) may be located at a remote location and connected to the other elements over a network.

Although not shown in FIG. 7B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (722), node Y (724)) in the network (720) may be configured to provide services for a client device (726). For example, the nodes may be part of a cloud computing system. The nodes may include functionality to receive requests from the client device (726) and transmit responses to the client device (726). The client device (726) may be a computing system, such as the computing system shown in FIG. 7A. Further, the client device (726) may include and/or perform all or a portion of one or more embodiments of the invention.

The computing system or group of computing systems described in FIG. 7A and 7B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 7A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 7A, while performing one or more embodiments of the invention, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 7A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, data containers (database, table, record, column, view, etc.), identifiers, conditions (comparison operators), functions (e.g., join, full join, count, average, etc.), sorts (e.g., ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 7A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 7A and the nodes and/or client device in FIG. 7B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method comprising:
obtaining, via a communication interface of a computing system, an identifier of a target entity;
obtaining, by at least one computer processor of the computing system, a candidate match between the target entity and a candidate application user;
filtering, by the at least one computer processor, a plurality of transaction records of a plurality of application users to obtain a subset of the plurality of transaction records each involving a transaction with the target entity, the plurality of application users excluding the candidate application user,
determining, for each transaction record in the subset and by the at least one computer processor, whether a matching transaction record exists in a plurality of candidate users transaction records of the candidate application user;
validating, by the at least one computer processor, the candidate match when at least a threshold amount of transaction records in the subset has the matching transaction record in the plurality of candidate users transaction records;
linking, in persistent storage of the computing system, the target entity to the candidate application user.

2. The method of claim 1, wherein the threshold amount is all of the transaction records in the subset.

3. The method of claim 1, wherein obtaining the candidate match comprises:
calculating a normalized distance between the target entity and the candidate application user; and
setting the target entity and the candidate application user as the candidate match based on the normalized distance satisfying a threshold distance.

4. The method of claim 3, wherein the normalized distance is based on a name of the target entity and a name of the candidate application user.

5. The method of claim 1, further comprising:
obtaining an address of the target entity,
wherein filtering the plurality of transaction records comprises selecting transaction records in the plurality of transaction records that comprise the address as a counterparty of the transaction.

6. The method of claim 1, further comprising:
validating a validation procedure of the validating the candidate match.

7. The method of claim 6, wherein validating the validation procedure comprises:
selecting a randomized sample of application user transaction records;
determining, for each transaction record in the subset, whether a matching transaction record exists in the randomized sample; and
confirming the validation procedure when less than a threshold percentage of transaction records in the subset have the matching transaction record in the randomized sample.

8. The method of claim 1, wherein determining a matching transaction record exists for a transaction record in the subset comprises:
determining that a candidate user transaction record is equal and opposite of the transaction record in the subset.

9. The method of claim 1, wherein determining a matching transaction record exists for a transaction record in the subset comprises:
determining that a candidate user transaction record has a same timestamp and amount and is opposite to the transaction record in the subset.

10. The method of claim 9, wherein the opposite comprises at least one selected from a group consisting of:
a bill when the transaction record in the subset is an invoice;
an invoice when the transaction record in the subset is a bill;
an income when the transaction record in the subset is a cost; and
a cost when the transaction record in the subset is an income.

11. A system comprising:
persistent storage comprising a data repository comprising a plurality of transaction records and a plurality of candidate users transaction records;
a communication interface configured to obtain an identifier of a target entity;
at least one computer processor executing:
a matching model executing on the at least one computer processor, the matching model configured to generate a candidate match between a target entity and a candidate application user; and
a validation model executing on the at least one computer processor, the validation model configured to:
filter the plurality of transaction records of a plurality of application users to obtain a subset of the plurality of transaction records each involving a transaction with the target entity, the plurality of application users excluding the candidate application user,
determine, for each transaction record in the subset, whether a matching transaction record exists in the plurality of candidate users transaction records of the candidate application user,
validate the candidate match when at least a threshold amount of transaction records in the subset has the matching transaction record in the plurality of candidate users transaction records, and
link, in the persistent storage, the target entity to the candidate application user.

12. The system of claim 11, further comprising:
a firewall configured to block access to the plurality of transaction records and the plurality of candidate users transaction records to unauthorized users,
wherein the target entity is an unauthorized user prior to validation and an authorized user after validation.

13. The system of claim 11, further comprising:
a software application for populating the plurality of transaction records.

14. The system of claim 11, wherein the matching model is configured to:
calculate a normalized distance between the target entity and the candidate application user; and
set the target entity and the candidate application user as the candidate match based on the normalized distance satisfying a threshold distance.

15. The system of claim 14, wherein the normalized distance is based on a name of the target entity and a name of the candidate application user.

16. The system of claim 11, wherein the validation model is configured to:
obtain an address of the target entity,
wherein filtering the plurality of transaction records comprises selecting transaction records in the plurality of transaction records that comprise the address as a counterparty of the transaction.

17. The system of claim 11, wherein the validation model is further configured to:
validate a validation procedure of the validating the candidate match.

18. The system of claim 17, wherein validating the validation procedure comprises:
selecting a randomized sample of application user transaction records;
determining, for each transaction record in the subset, whether a matching transaction record exists in the randomized sample; and
confirming the validation procedure when less than a threshold percentage of transaction records in the subset have the matching transaction record in the randomized sample.

19. A method comprising:
obtaining, via a communication interface of a computing system, an identifier of a target entity;
calculating, by at least one computer processor of the computing system, a normalized distance between a target entity and each of a plurality of candidate application users;
selecting, by the at least one computer processor, a candidate application user from the plurality of candidate application users as a candidate match with the target entity based on the normalized distance satisfying a threshold distance;
selecting, by the at least one computer processor, a subset of transaction records in a plurality of transaction records of a plurality of application users that comprise an address of the target entity as a counterparty of a transaction, the plurality of application users excluding the candidate application user,
determining, for each transaction record in the subset and by the at least one computer processor, whether a matching transaction record exists in a plurality of candidate user transaction records of the candidate application user, wherein determining a matching transaction record exists for a transaction record in the subset comprises:
determining that a candidate user transaction record is equal and opposite to the transaction record in the subset;
validating, by the at least one computer processor, the candidate match when at least a threshold amount of transaction records in the subset has the matching transaction record in the plurality of candidate users transaction records; and
linking, in persistent storage of the computing system, the target entity to the candidate application user.

20. The method of claim 19, further comprising validating the validating of the candidate match by:
selecting a randomized sample of application user transaction records;
determining, for each transaction record in the subset, whether a matching transaction record exists in the randomized sample; and
confirming the validating when less than a threshold percentage of transaction records in the subset have the matching transaction record in the randomized sample.
